(19) United States
(12) Patent Application Publication
(10) Pub. No.: US 2010/0315801 A1
(43) Pub. Date: Dec. 16, 2010

(54) Structure of desk lamp

(76) Inventors: Ching-Huei WU, San Chung City (TW); Chih-Hsien WU, SAn Chung City (TW); Ching-Li CHOU, San Chung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/457,403

(22) Filed: Jun. 10, 2009

(51) Int. Cl. F21V 13/00; F21S 6/00

(52) U.S. Cl. 362/33; 362/257

(57) ABSTRACT

Disclosed is a structure of desk lamp, including a base, a support arm, and a lampshade. The lampshade is composed of a first lampshade portion and a second lampshade portion. The first and second lampshade portions are relatively movable with respect to each other and are removably coupled to each other (for being fixed together or separated from each other) to allow the second lampshade portion to selectively serve as a separate portable lighting device thereby making the use thereof easy and providing excellent convenience of use.

### FIELD OF THE INVENTION

The present invention relates to a structure of desk lamp, and in particular to a desk lamp structure comprising a separable lampshade that can individually serve as portable lighting device.

### BACKGROUND OF THE INVENTION

Modern people use lighting devices, such as a desk lamp, to improve illumination of a corner of an isolated area where lighting is weak in order to supply sufficient lighting for protection of human eyes against potential risk of eyesight damages caused by long term insufficiency of lighting, such as shortsightedness and blurring of sight.

With reference to FIG. 6 of the attached drawings, which shows a perspective view of the structure of a conventional desk lamp, generally designated as 400, the conventional desk lamp 400 comprises a base 410, an extension arm 420, and a lighting tube hood or lampshade 430. The base 410 is coupled to an end of the extension arm 420, while the lampshade 430 is coupled to an opposite end of the extension arm 420. The base 410 is placed flat on for example a desktop, and the extension arm 420 adjustably sets the. lampshade 430 to a desired orientation according to the needs of a user. However, the desk lamp 400 can only be used by being placed on a desktop and is not easy for carrying. This reduces the usability thereof.

In view of this problem, the present invention aims to provide a structure of desk lamp that is easy to carry and enhances the use thereof in order to reduce costs and enhance production performance.

### SUMMARY OF THE INVENTION

A primary objective of the present invention is to provide a structure of desk lamp comprising a lampshade that is composed of first and second portions which can be selectively coupled together or separated from each other to allow the second lampshade portion to serve as a separate portable lighting device thereby making the use thereof easy and providing excellent convenience of use.

To realize the above objectives, the present invention provides a desk lamp comprising a base, a support arm connected to the base, and a lampshade connected to the support arm. The lampshade comprises a lampshade base, which comprises a first base member and a second base member, the first base member forming a plurality of first coupling sections, the second base member forming a plurality of second coupling sections corresponding to the first coupling sections; a lampshade cover, which comprises a first cover member corresponding to the first base member and a second cover member corresponding to the second base member, the first cover member forming a first positioning section, the second cover member forming an opening, the first base member and the first cover member being secured together to form a first lampshade portion, the second base member and the second cover member being secured together to form a second lampshade portion, the first coupling sections and the second coupling sections mating each other and coupled together to have the first lampshade portion coupled to the second lampshade portion to define an accommodation chamber; and a lighting source, which is received in the accommodation chamber and comprises a power source and a power source connection member for connection with a power cable, whereby the first coupling sections and the second coupling sections are allow to perform relative movement therebetween (such as being coupled together or detached from each other) to have the first lampshade portion and the second lampshade portion selectively coupled together or detached from each other and the power source connection member is allowed for relative movement to selectively supply electrical power to the lighting source for emitting light that projects through the opening. As such, the operation is made easy and excellent convenience of use is provided.

### BRIEF DESCRIPTION OF THE DRAWINGS

The present invention will be apparent to those skilled in the art by reading the following description of a preferred embodiment thereof with reference to the drawings, in which:

FIG. 1 is a perspective view of a desk lamp constructed in accordance with the present invention;

FIG. 2 is an exploded view of the desk lamp of the present invention;

FIGS. 3 and 4 are schematic views of a lampshade base and a lampshade cover of the desk lamp in accordance with the present invention;

FIG. 5 is a schematic view illustrating a condition of use of the lampshade base and the lampshade cover of the desk lamp of the present invention; and

FIG. 6 is a perspective view of a conventional desk lamp.

### DETAILED DESCRIPTION OF THE PREFERRED EMBODIMENT

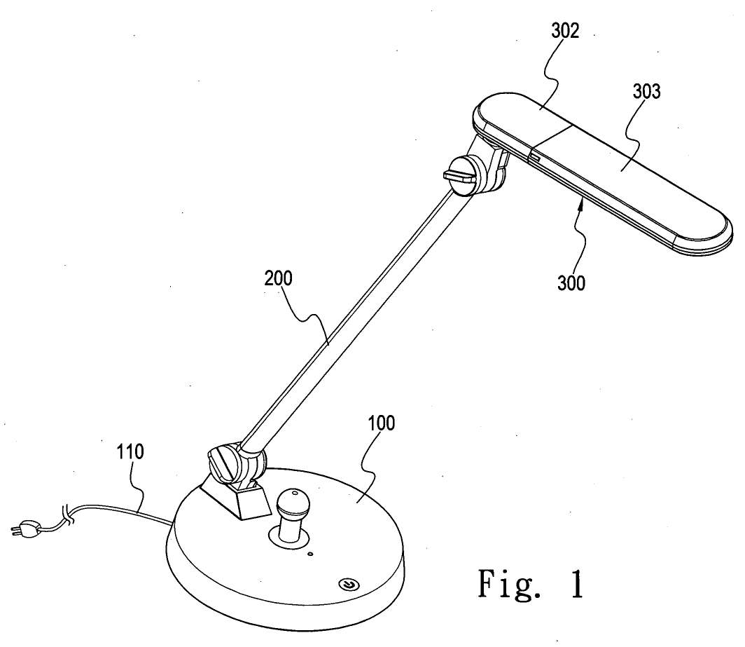

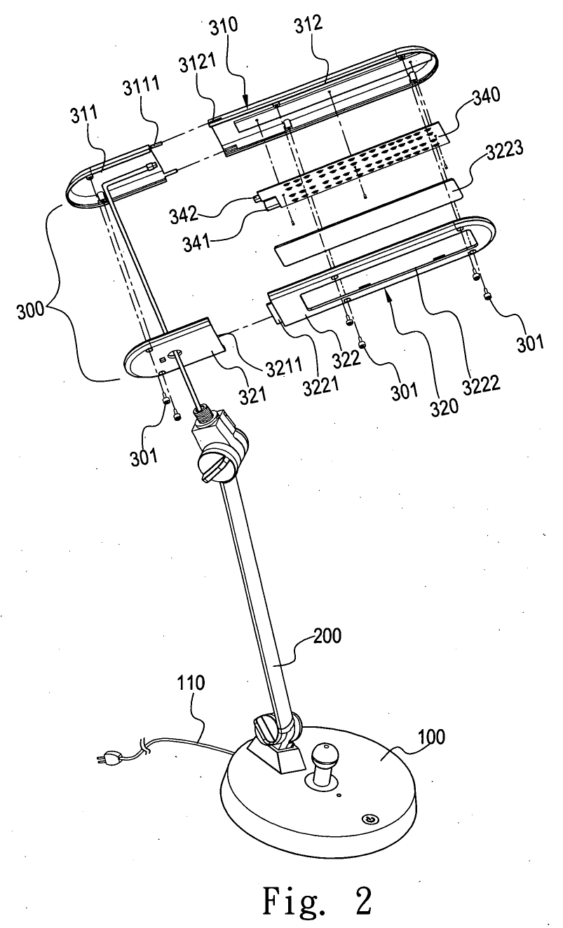

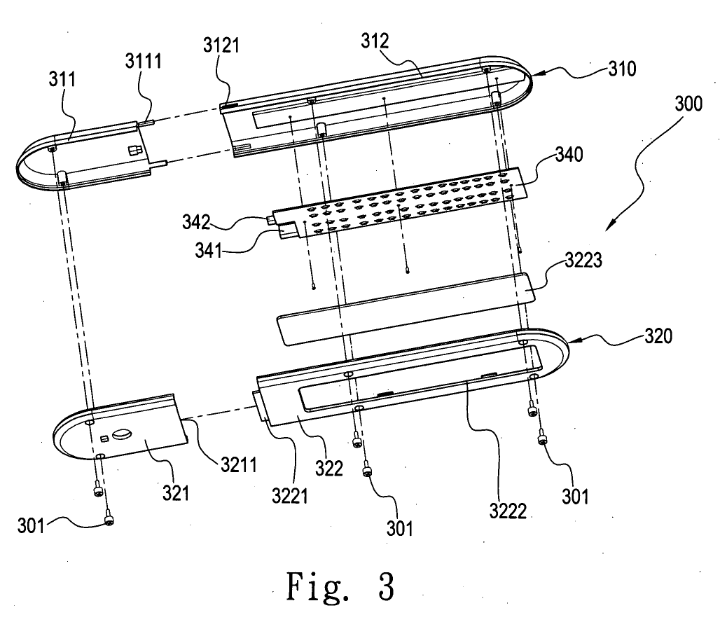

With reference to FIGS. 1-5, which respectively show a perspective view of a desk lamp of the present invention, an exploded view of the desk lamp of the present invention, and views of a lampshade base and lampshade cover of the desk lamp of the present invention, the desk lamp of the present invention comprises a base 100, a support arm 200 connected to the base 100, and a lampshade 300 connected to the support arm 200. The base 100 comprises a power cable 110 for supplying electrical power. The lampshade 300 comprises a lampshade base 310, a lampshade cover 320, and a lighting source 340. The lampshade base 310 and the lampshade cover 320 are secured together with fasteners 301, such as bolts, to define an accommodation chamber 330, whereby the lighting source 340 is received in the accommodation chamber 330.

The lampshade base 310 is composed of a first base member 311 and a second base member 312. The first base member 311 forms a plurality of first coupling sections 3111 (such as resilient projections), and the second base member 312 forms a plurality of second coupling sections 3121 (such as openings) corresponding to the first coupling sections 3111.

The lampshade cover 320 is composed of a first cover member 321 corresponding to the first base member 311 and a second cover member 322 corresponding to the second base member 312. The first cover member 321 forms a first positioning section 3211 and the second cover member 322 forms a second positioning section 3221, an opening 3222, and a transparent lid 3223 set in the opening 3222. The first base member 311 and the first cover member 321 are secured together with fasteners 301 to form a first lampshade portion 302, and the second base member 312 and the second cover member 322 are secured together with fasteners 301 to form a second lampshade portion 303. The first coupling sections 3111 and the second coupling sections 3121 mate each other and are coupled together and the first positioning section 3211 and the second positioning section 3221 mate each other and are coupled together so that the first lampshade portion 302 is coupled to the second lampshade portion 303 to define the accommodation chamber 330.

The lighting source 340 comprises a device that emits lights, such as a circuit board carrying light-emitting diodes or a lighting tube connected to a control circuit board and is set in the accommodation chamber 330 formed by coupling the lampshade base 310 and the lampshade cover 320 together. The light emitting from the lighting source 340 projects outward through the opening 3222 of the lampshade cover 320. The lighting source 340 is provided with a power source 341 (such as a storage battery) and a power source connection member 342 (such as an electrical conduction means, for example a male/female connector or electrically conductive spring plate). Electrical connection with an external power source can be established with the power source connection member 342 and the power cable 110 of the base 100 and also electrical power can be stored in the power source 341, whereby when the first coupling sections 3111 are detached from the second coupling sections 3121 to separate the first lampshade portion 302 from the second lampshade portion 303 and the power source connection member 342 is separated from the power cable 110, the power source 341 functions to supply electrical power to the lighting source 340 to allow the lighting source 340 to provide light that projects through the opening 3222.

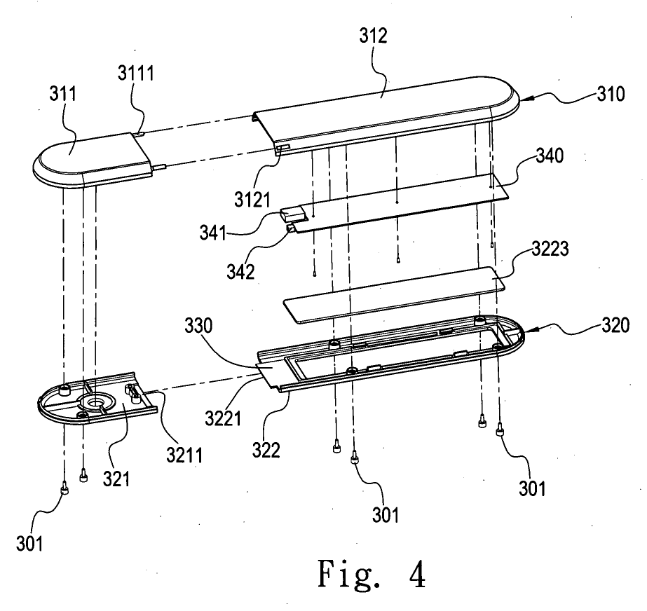

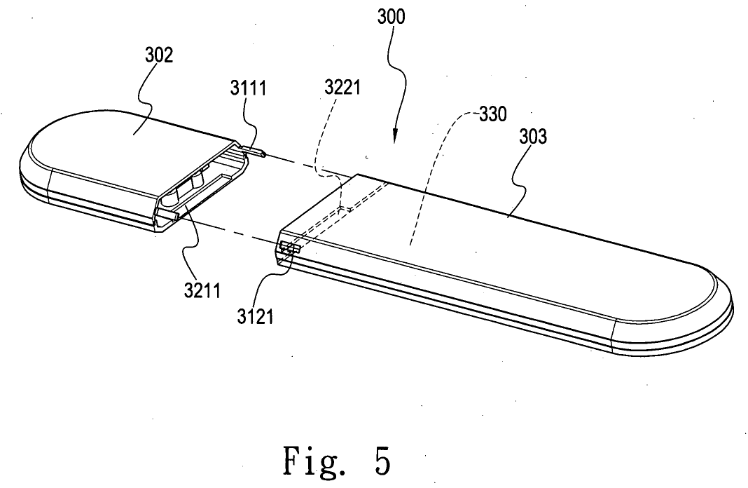

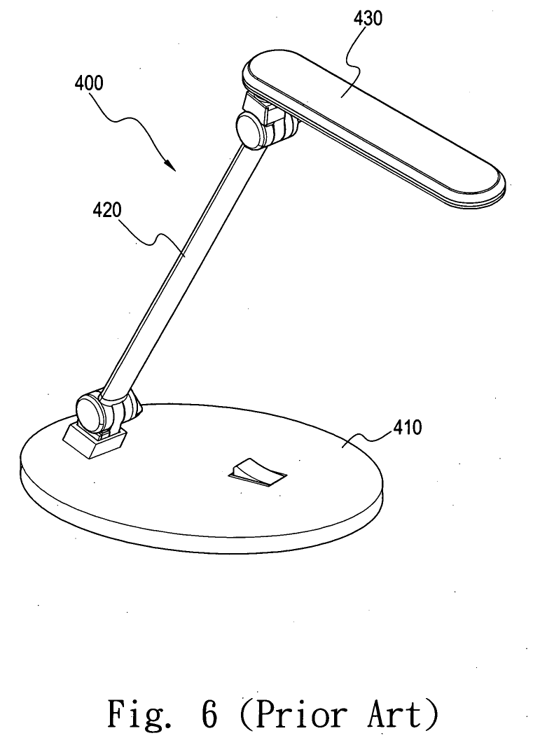

Further referring to FIGS. 4 and 5, which show the condition of use of the lampshade base and the lampshade cover of the desk lamp structure of the present invention, first of all, the lighting source 340 is placed in the opening 3222 of the lampshade cover 320 and the first base member 311 of the lampshade base 310 is put opposing to the first cover member 321 of the lampshade cover 320 and are secured together with the fasteners 301 to form the first lampshade portion 302. Also, the second base member 312 of the lampshade base 310 is put opposing to the second cover member 322 of the lampshade cover 320 and they are secured together with the fasteners 301 to form the second lampshade portion 303. The first coupling sections 3111 and the second coupling sections 3121 then mate each other and are coupled together and the first positioning section 3211 mates and is coupled to the second positioning section 3221 to have the first lampshade portion 302 and the second lampshade portion 303 coupled together. In other words, the lighting source 340 is housed in the accommodation chamber 330 formed by coupling the lampshade base 310 and the lampshade cover 320 together. The light emitting from the lighting source 340 projects outward through the opening of the lampshade cover 320 to serve as a lighting device.

Further, the coupling pieces 3111 are resilient elements, whereby a user may depress the coupling pieces 3111 to cause the coupling pieces 3111 to disengage from the second coupling sections 3121 and having the first positioning section 3211 and the second positioning section 3221 separating from each other so as to separate the first lampshade portion 302 and the second lampshade portion 303 from each other. Further, since the power source connection member 342 of the lighting source 340 can be electrical conduction means, such as a male/female connector or an electrically conductive spring plate, when the first lampshade portion 302 and the second lampshade portion 303 are separated, the power source 341 can be readily detached from the power cable 110, whereby relative movement therebetween (such as being coupled to each other or being detached from each other) is made easy. Since the lighting source 340 is provided with the power source 341 for storage of electrical power, when the first lampshade portion 302 and the second lampshade portion 303 are separated, the power source 341 may supply electrical power to the lighting source 340 to energize the lighting source 340 for emitting light that projects through the opening 3222 of the second cover member 322. In this way, the second lampshade portion 303 of the lampshade 300 may serve as a portable lighting device, which facilitates easy portability by a user and thus enhances the convenience thereof.

To summarize, the desk lamp in accordance with the present invention comprises a support arm connected to both a base and a lampshade and the lampshade is composed of a first lampshade portion and a second lampshade portion. The first lampshade portion comprises a plurality of first coupling sections and first positioning section, while the second lampshade portion comprises a plurality of second coupling sections and a second positioning section. Through mating and mutual coupling between the first coupling sections with the second coupling sections, the first lampshade portion and the second lampshade portion are coupled together. Further, a user may depress the coupling pieces to have the coupling pieces disengaging from the second coupling sections and having the first positioning section separating from the second positioning section, so as to separate the first lampshade portion from the second lampshade portion. Since the lighting source is provided with a power source for storage of electrical power, when the first lampshade portion and the second lampshade portion are separated from each other, the power source may supply electrical power to the lighting source to energize the lighting source for emitting light that projects through the opening of the second cover member, so that the second lampshade portion of the lampshade may serve as a portable lighting device, which facilitates relative movement (such as being coupled together or being separated from each other) and provides excellent use convenience.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A desk lamp comprising a base, a support arm connected to the base, and a lampshade connected to the support arm, the base comprising a power cable for supplying of electrical power, the lampshade comprising:
a lampshade base, which comprises a first base member and a second base member, the first base member forming a plurality of first coupling sections, the second base member forming a plurality of second coupling sections corresponding to the first coupling sections;
a lampshade cover, which comprises a first cover member corresponding to the first base member and a second cover member corresponding to the second base member, the second cover member forming an opening, the first base member and the first cover member being secured together to form a first lampshade portion, the second base member and the second cover member being secured together to form a second lampshade portion, the first coupling sections and the second coupling sections mating each other and coupled together to have the first lampshade portion coupled to the second lampshade portion to define an accommodation chamber; and
a lighting source, which is received in the accommodation chamber and comprises a power source and a power source connection member for connection with the power cable, whereby the first coupling sections and the second coupling sections are allow to perform relative movement therebetween to have the first lampshade portion and the second lampshade portion selectively coupled together or detached from each other and the power source connection member is allowed for relative movement to selectively supply electrical power to the lighting source for emitting light that projects through the opening.

2. The desk lamp as claimed in claim 1, wherein the first coupling sections comprise resilient elements and the second coupling sections comprises openings.

3. The desk lamp as claimed in claim 1, wherein the lampshade base and the lampshade cover are secured together with fasteners.

4. The desk lamp as claimed in claim 3, wherein the fasteners comprise bolts.

5. The desk lamp as claimed in claim 1, wherein the second cover member comprises a transparent lid set in the opening.

6. The desk lamp as claimed in claim 1, wherein the lighting source selectively comprises a circuit board carrying light-emitting diodes or a lighting tube connected to a control circuit board.

7. The desk lamp as claimed in claim 1, wherein the power source comprises a storage battery.

8. The desk lamp as claimed in claim 1, wherein the power source connection member selectively comprises a male/female connector or an electrically conductive spring plate.

9. The desk lamp as claimed in claim 1, wherein the first cover member forms a first positioning section and the second cover member forms a second positioning section corresponding to the first positioning section, the first and second positioning sections being mateable and thus coupled to each other.
